(19) United States
(12) Patent Application Publication
(10) Pub. No.: US 2009/0133855 A1
(43) Pub. Date: May 28, 2009

(54) HEAT DISSIPATION DEVICE AND ASSEMBLY METHOD THEREOF

(75) Inventors: YI-SHIH HSIEH, Tu-Cheng (TW); JIN-JUN RAO, Shenzhen City (CN)

Correspondence Address: PCE INDUSTRY, INC.;ATT. Steven Reiss, 458 E. LAMBERT ROAD, FULLERTON, CA, 92835, US

(73) Assignees: FURUI PRECISE COMPONENT (KUNSHAN) CO., LTD., KunShan City (CN); FOXCONN TECHNOLOGY CO., LTD., Tu-Cheng (TW)

(21) Appl. No.: 12/274,336

(22) Filed: Nov. 19, 2008

(30) Foreign Application Priority Data
Nov. 23, 2007 (CN) 200710124770.7

(51) Int. Cl. F28D 15/00; B23P 11/00

(52) U.S. Cl. 165/104.26; 29/428

(57) ABSTRACT

A heat dissipation device includes a heat pipe having a condenser section and a layer of solid-state solder film on an exterior surface of the condenser section, a heat sink having a plurality of spaced fins, each of which has an aperture. The condenser section of the heat pipe fits into the apertures of the fins. The heat sink with the condensing section received therein is heated and the solid-state solder film melts, filling gaps between the heat pipe and the fins. A method of assembling the device is also provided.

### BACKGROUND

1. Field of the Disclosure

The disclosure generally relates to heat dissipation, and particularly to a heat dissipation device incorporating a heat pipe and fins and an assembly method thereof.

2. Description of Related Art

It is well-known that heat is generated by electronic components such as central processing units (CPUs). If the generated heat is not rapidly and efficiently removed, the electronic component may overheat and the performance thereof may be significantly degraded. Generally, a heat dissipation device including a heat pipe and a plurality of fins is used for cooling a CPU. The heat pipe has low thermal resistance in heat transfer due to a phase change mechanism employing working fluid in the heat pipe. The heat pipe includes an evaporator section thermally contacting the CPU and a condenser section. The fins are connected to the condenser section, dissipating heat transferred from the CPU by the heat pipe. However, an air gap occurs between the heat pipe and the fins, reducing heat transmission efficiency from the heat pipe to the fins.

To overcome such occurrence, thermal medium material, material with high thermal conductivity, is filled between the fins and the heat pipe, soldering the heat pipe and the fins together. Generally, the thermal medium material used is in the form of viscous solder paste, composed of particles of a metal alloy such as tin (Sn) or silver (Ag) together with a flux agent. A long tunnel is formed in the resulting fin assembly for receiving the heat pipe. After solder paste is spread on an inner surface of the tunnel, the heat pipe is inserted thereinto. However, due to its viscosity at normal temperatures, it is difficult for the solder paste to spread evenly throughout the length of the tunnel, with particles of the metal alloy of the solder paste becoming more unevenly distributed after the heat pipe is received. The quality of the join between the heat pipe and the metal fins is affected, which reduces heat exchange efficiency. Further, the solder paste is easily forced out of the tunnel of the fin assembly when the heat pipe is inserted, wasting the solder paste.

What is needed, therefore, is a heat dissipation device which overcomes the described limitations.

### SUMMARY

A heat dissipation device and an assembly method thereof are disclosed. The method includes providing a heat pipe having a condenser section, coating a layer of solid-state solder film on an exterior surface thereof, providing a heat sink having a plurality of spaced fins, each defining an aperture, inserting the condenser section of the heat pipe into the apertures, heating the heat sink with the condensing section of the heat pipe therein to melt the solid-state solder film and fill gaps between the heat pipe and the fins of the heat sink, and cooling the assembly.

### BRIEF DESCRIPTION OF THE DRAWINGS

FIG. 1 is an isometric, assembled view of a heat dissipation device in accordance with a first embodiment.

FIG. 2 is an exploded, isometric view of the heat dissipation device of FIG. 1.

FIG. 3 is an isometric, assembled view of a heat dissipation device in accordance with a second embodiment.

FIG. 4 is an exploded, isometric view of the heat dissipation device of FIG. 3.

### DETAILED DESCRIPTION

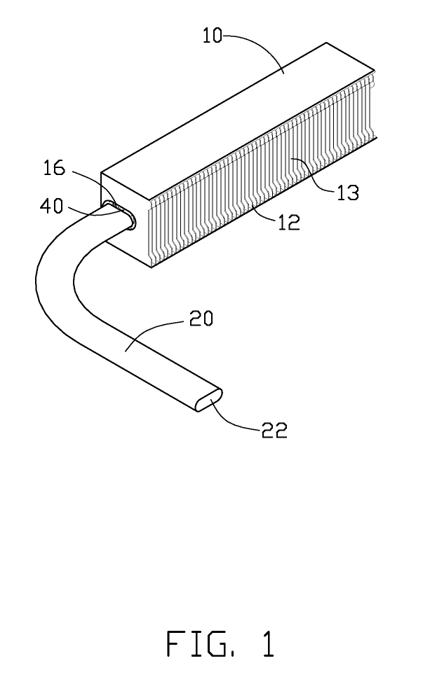

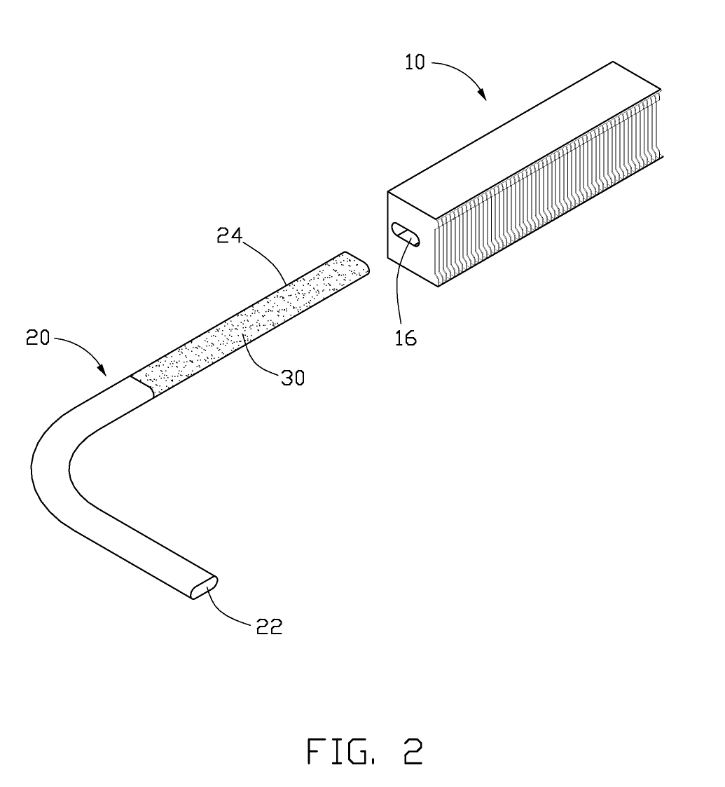

Referring to FIGS. 1 and 2, a heat dissipation device in accordance with a first embodiment is shown. The heat dissipation device includes a heat sink 10, a flat heat pipe 20 extending into the heat sink 10, and a solder layer 40 filled between the heat sink 10 and the heat pipe 20.

The heat sink 10 includes a plurality of stacked parallel fins 12. A plurality of air passages 13 are formed between the fins 12 through which cooling air flows. Each of the fins 12 is substantially rectangular and defines a substantially elliptical aperture 16 in a center portion thereof, receiving the heat pipe 20.

The heat pipe 20 is L-shaped and includes an evaporator section 22 thermally contacting an electronic component (not shown), and a condenser section 24 with a layer of solid-state solder film 30 coated thereon. The solid-state solder film 30 is coated on an exterior surface of the condenser section 24 before the heat pipe 20 is inserted into the heat sink 10. The solid-state solder film 30 is formed by following steps. A tin alloy such as Sn—Bi (tin-bismuth) bar/ingot, is provided. The tin alloy bar/ingot is arranged in a container (not shown) and heated to about 139° C. to melt. After melting is complete, the condenser section 24 of the heat pipe 20 is immersed in the molten tin alloy. Condenser section 24 of the heat pipe 20 removed and cooled. A layer of tin alloy adhering to an exterior surface of the condenser section 24 forms the solid-state solder film 30, which can be about 0.1 millimeter (mm) to 0.2 mm thick, considerably thinner than a solder paste layer. Thus, an inside dimension of the apertures 16 of the fins 12 is substantially equal to an outside dimension of the condenser section 24 of the heat pipe 20.

After the solid-state solder film 30 on the condenser section 24 is fully cooled, the condenser section 24 of the heat pipe 20 is inserted into the fins 12 of the heat sink 10. The heat sink 10 and the heat pipe 20 are placed into a heating apparatus (not shown) such as a reflow oven or a soldering furnace. Since the solid-state solder film 30 has a lower melting point than the heat pipe 20 and the fins 12 of the heat sink 10, at high temperatures, such as 139° C., the solid-state solder film 30 melts and flows evenly into gaps between the exterior surface of the condenser section 24 of the heat pipe 20 and interior surfaces of the apertures 16 of the fins 12. The time needed to seal the fins 12 of the heat sink 10 and heat pipe 20 in the heating apparatus depends on the temperature of the heating apparatus, the size of the heat pipe 20, and heat sink 10, and the volume of the solid-state solder film 30. After the melted solid-state solder film 30 fully fills the gaps of the heat sink 10 and the heat pipe 20, the apparatus is cooled and the solder layer 40 is formed, securely combining the heat sink 10 and the condenser section 24 of the heat pipe 20.

In this embodiment of the heat dissipation device, the solid-state solder film 30 is evenly coated on the condenser section 24 of the heat pipe 20 before the heat pipe 20 is inserted between fins 12 of the heat sink 10. When the heat pipe 20 is inserted into the apertures 16 of the fins 12, little of the solid-state solder film 30 is scraped from the heat pipe 20 by the fins 12. Solder material wastage is thus avoided. Additionally, when assembled heat sink 10 and heat pipe 20 are heated, the solid-state solder film 30 flows evenly into gaps between the exterior surface of the heat pipe 20 and interior surfaces of the apertures 16 of the fins 12, enhancing the integrity of the join therebetween and increasing heat exchange efficiency thereof commensurately. Further, since the tin alloy material used needs only be provided in bar/ingot form, rather than milled into particles and integrated into solder paste, material costs of the heat dissipation are additionally conserved.

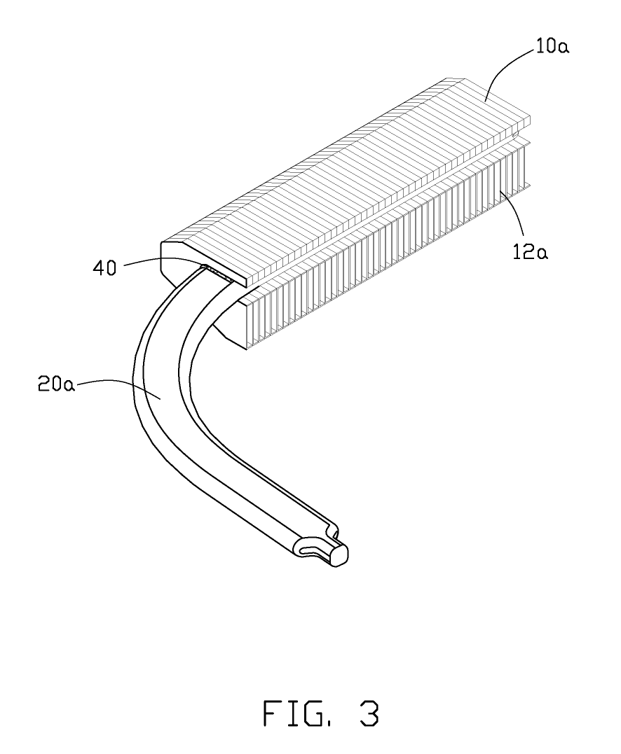

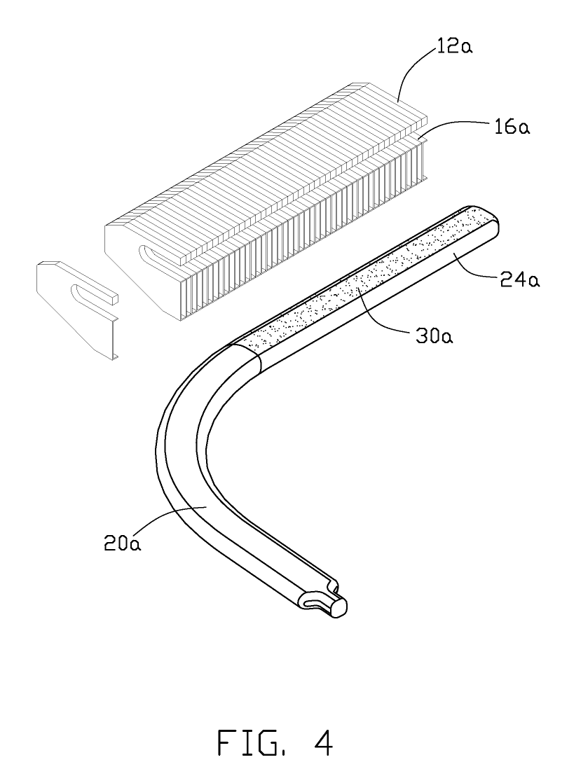

Referring to FIGS. 3 and 4, a heat dissipation device in accordance with a second embodiment is shown. The heat dissipation device includes a heat sink 10a and a flat heat pipe 20a having a condenser section 24a. The heat sink 10a includes a plurality of stacked parallel fins 12a. Each of the fins 12a defines a substantially U-shaped aperture 16a in a middle portion thereof. An open end of the aperture 16a extends through a right side of each of the fins 12a. A layer of solid-state solder film 30a coated on a portion of condenser section 24a has a U-shaped cross-section corresponding to inner surfaces of the apertures 16 of the fins 12. The fins 12 and the heat sink 10 are assembled as in the first embodiment.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of assembling a heat dissipation device comprising:
providing a heat pipe having a condenser section;
coating a layer of solid-state solder film on an exterior surface of the condenser section of the heat pipe;
providing a heat sink having a plurality of spaced fins, each of the fins defining an aperture therein;
inserting the condenser section of the heat pipe into the apertures of the fins;
heating the heat sink with the condensing section of the heat pipe inserted therein, thereby melting the solid-state solder film and filling gaps between the heat pipe and the fins of the heat sink therewith; and
cooling the melted solid-state solder film between the fins and the heat pipe to join the heat pipe to the fins.

2. The method of claim 1, wherein the solid-state solder film is tin alloy.

3. The method of claim 2, wherein the solid-state solder film is formed by immersing the condenser section of the heat pipe in molten tin alloy, and then taking the heat pipe out of the molten tin alloy and cooling down.

4. The method of claim 3, wherein the molten tin alloy is formed by melting tin alloy in bar/ingot form.

5. The method of claim 4, wherein the tin alloy is an Sn—Bi alloy.

6. The method of claim 1, wherein the solid-state solder film is 0.1 mm to 0.2 mm thick.

7. The method of claim 1, wherein the aperture is substantially U-shaped, and an open end of the aperture extends through a side of each of the fins.

8. The method of claim 7, wherein the solid-state solder film has a U-Shaped cross-section.

9. The method of claim 1, wherein the heat pipe is flat and L-shaped.

10. A heat dissipation device comprising:
a heat sink having a plurality of spaced fins, each of the fins defining an aperture therein; and
a heat pipe having a condenser section with a layer of solid-state solder film tightly coated thereon, the condenser section of the heat pipe being inserted into the apertures of the fins;
wherein the solid-state solder film is coated on the condensing section of the heat pipe before the heat pipe is inserted into the aperture of the heat pipe and then melts and evenly flows into gaps between the exterior surface of the condenser section and interior surfaces of the apertures of the fins, forming a solder layer between the condenser section of heat pipe and fins of the heat sink and securely joining the fins with the heat pipe.

11. The heat dissipation device of claim 10, wherein the layer of solid-state solder film is formed by immersing the condenser section of the heat pipe in molten solder, and taking the heat pipe out of the molten solder and cooling the heat pipe down.

12. The heat dissipation device of claim 11, wherein the solid-state solder film is tin alloy.

13. The heat dissipation device of claim 10, wherein the solder layer formed between the condenser section of heat pipe and fins of the heat sink is 0.1 mm to 0.2 mm thick.

14. The heat dissipation device of claim 10, wherein the aperture is substantially U-shaped, and an open end of the aperture extends through a side of each of the fins.

15. The heat dissipation device of claim 14, wherein the solid-state solder film has a U-Shaped cross-section.

16. The heat dissipation device of claim 10, wherein the heat pipe is flat and L-shaped.
